(19) United States
(12) Patent Application Publication
(10) Pub. No.: US 2019/0319285 A1
(43) Pub. Date: Oct. 17, 2019

(54) RENEWABLE ENERGY SYSTEM

(71) Applicant: Marvin Milos, BALGONIE (CA)

(72) Inventor: Marvin Milos, BALGONIE (CA)

(21) Appl. No.: 16/313,518

(22) PCT Filed: Jun. 27, 2017
(86) PCT No.: PCT/CA2017/000162

§ 371 Date: Dec. 27, 2018

(30) Foreign Application Priority Data
Jun. 27, 2016 (CA) 2933996

(51) Int. Cl. H01M 8/0606; C25B 1/04; C02F 1/461

(52) U.S. Cl. CPC H01M 8/0606; C25B 1/04; C02F 2103/08; C02F 2303/10; C02F 1/461

(57) ABSTRACT

A system for using electrical energy generated by renewable sources is used to hydrolyse water into hydrogen and oxygen. The hydrogen and oxygen can be used on-site for the generation of electrical power, or stored in liquid form for later use. Exhaust from a power generator can provide a system for purifying water from non-potable sources, and as an input stream for the electrolysis system. Also described is a self-contained fueling station that can provided purified hydrogen for vehicles running on such a fuel.

### FIELD OF THE INVENTION

The invention is in the field of apparatus and methods for the use of renewable energy sources to generate electrical power.

### BACKGROUND

More than 20 TWh of electrical energy are generated worldwide each year. Of this, only about 10-15% is generated from renewable sources of energy such as wind and solar power. The majority of electrical energy is produced by the combustion of non-renewable sources such as coal, oil and natural gas.

Combustion-based power generation results in significant emissions. For example, in 2015, emissions of CO₂ in the United States alone amounted to 1.925 million metric tons, or about 37% of the total US energy-related emissions. The result of this is a significant production of greenhouse gases that when released into the atmosphere contribute to global climate change.

There has been progress in using renewable energy sources such as wind or solar energy to augment or replace non-renewable sources used for electrical power generation. For example, U.S. Pat. No. 7,964,981 discloses a solar and wind energy converter that converts solar and wind energy into mechanical energy for driving an electrical generator. Similarly, U.S. Pat. No. 8,330,296 discloses a turbine system that uses wind and solar energy to either drive a generator or generate power directly from a photovoltaic system.

There are countless other patent disclosures that describe various means of turning mechanical (wind or sea currents) or solar energy into electrical power. Mechanical sources are typically used to directly drive electrical generation systems, while solar systems typically convert light into electricity via a variety of photovoltaic cells.

A limitation of all these systems is that they provide no means of storing energy for later use, but rather simply load electrical energy onto an energy distribution grid in real time. Thus, a significant limitation is that there will be periods where production capacity exceeds demands, and similarly, times when demand outstrips production. When production exceeds demands, generation capacity is effectively wasted. When demand exceeds production, consumers of electricity must acquire their power from other sources, such as power plants fueled by non-renewable resources.

What is therefore needed is a system in which excess electrical energy can be converted into a storage form that can later be used to drive an electrical generation system for use when the initial source of energy (e.g., wind, light) is not available in sufficient quantities to meet electrical demand.

### SUMMARY OF THE INVENTION

Only a fraction of the world electrical needs is currently met though renewable energy sources hydroelectric, or solar power. As a result, most electrical power is generated from non-renewable sources, typically fossil fuels. While fossil fuels currently enjoy an economic advantage over other forms of energy production, there are nonetheless considered to be a finite resource. In addition, fossil fuels create issues with respect to environmental contamination both during extraction, processing, transportation and use.

Accordingly, there is a desire to develop and make use of electrical generating systems that avoid the use of non-renewable resources where possible. Typically, the primary focus in developing electrical generation systems that use renewable sources of energy have been in the areas of hydroelectric, wind and solar power. Each of these has limitations due the nature of the processes involved. For example, hydroelectric power typically requires large rivers, dam systems and significant capital investment to be economically viable. In addition, restricting river courses to build hydroelectric facilities comes at environmental cost in lost land area due to flooding of reservoirs, displacement of wildlife and people and release of toxic chemicals from naturally occurring ground sources into water contained in the reservoir.

For wind and solar power, the challenges are somewhat different. Primarily, the drawback to generating power using wind or solar energy is that power production only occurs when either the wind is blowing or the sun is shining, and these times may not match those periods of maximum demands by consumers of electrical energy. When power production exceeds demand, potential energy is effectively wasted, and when demand outstrips production, consumers must turn to other sources of energy, such as non-renewable resources, to supply the missing electrical capacity.

In some embodiments, the present disclosure describes a system in which water is collected and purified by a combination of filtration and/or distillation to produce essentially pure water. Using electrical power from either wind turbines, photovoltaic arrays and the like, the water is electrolyzed into hydrogen and oxygen, which are captured, separated and stored in pressurized vessels. At a later point in time, the collected hydrogen and oxygen and combusted, for example in a hydrogen fuel cell to create electricity, or in a gas turbine, which drives an electrical generator.

In yet other embodiments, an unpurified source of water, such as seawater is used directly in a hydrolysis system to produce hydrogen and oxygen. In some cases, the hydrogen and oxygen can be fed directly to a fuel cell and burned to produce electricity. In other cases, the hydrogen and oxygen can be collected and stored for later use as a fuel source. Still other embodiments of the invention include a self-contained facility in which a renewable energy source is used to electrolyze water into hydrogen and oxygen. The hydrogen and oxygen can be stored on site for use as fuel for other purposes such as for refueling vehicles that operate on hydrogen fuel cells. A portion of the hydrogen and oxygen and be fed to an on-site fuel cell to produce electrical power for the self-contained facility. This allows operation in remote areas that may not have access to an existing electrical grid. Conveniently, the exhaust from the on-site fuel cell system, water, can be fed back via a closed loop system to provide the starting material for the fuel cell.

Thus, in some embodiments, the invention comprises a system for converting energy from a renewable energy source into a storable form of energy, the system comprising: a source of electrical energy, wherein the electrical energy is generated by a source from a source of renewable energy; an input stream, the input stream comprising water, an electrolysis system, the electrolysis system configured to use the source of electrical energy to convert the water into hydrogen and oxygen, wherein the electrolysis system further comprises separate hydrogen and oxygen output streams; a hydrogen storage system; an oxygen storage system; a power generator, wherein the power generator is configured to use at least a portion of the hydrogen and oxygen generated by the electrolysis system to produce electrical power; a collector system, the collector system configured to collected exhaust created by the power generator, wherein the exhaust from the collector system can provide the input stream for the electrolysis system; wherein the portion of hydrogen and oxygen not used by the power generator is available as a storable form of energy.

In some embodiments, the input stream is one of fresh water and sea water.

In some embodiments, the system further comprises a water treatment system, the water treatment system comprising at least one of a filtration system, a distillation system, and a deionizing system, the water treatment system configured to partially purify the input stream prior to introduction the input stream into the electrolysis system.

In some embodiments, the input stream comprises water recovered from the power generator.

In some embodiments, the system is configured to transmit electrical power to an electrical grid distribution system. In some embodiments, the system is configured to refuel vehicles that operate on hydrogen consuming fuel systems.

In some embodiments, there is also provided a method for converting energy from a renewable energy source into a storable form of energy, the method comprising: providing a source of electrical energy, wherein the electrical energy is generated by a source from a source of renewable energy; providing an input stream, the input stream comprising water, providing an electrolysis system, the electrolysis system configured to use the source of electrical energy to convert the water into hydrogen and oxygen, wherein the electrolysis system further comprises separate hydrogen and oxygen output streams; introducing water into the electrolysis system; operating the electrolysis system such that water is converted into hydrogen and oxygen gas; providing a hydrogen storage system; providing an oxygen storage system; providing a power generator, wherein the power generator is configured to use at least a portion of the hydrogen and oxygen generated by the electrolysis system to produce electrical power; providing a collector system, the collector system configured to collected exhaust created by the power generator, wherein the exhaust from the collector system can provide the input stream for the electrolysis system; and storing the portion of the hydrogen and oxygen not used by the power generator.

In some embodiments of the method, the input stream is one of fresh water and sea water.

In some embodiments, the method further comprises providing a water treatment system, the water treatment system comprising at least one of a filtration system, a distillation system, and a deionizing system, the water treatment system configured to partially purify the input stream prior to introduction the input stream into the electrolysis system, and processing the input stream with the water treatment system prior to introducing the input stream into the electrolysis system.

In some embodiments, the method further comprises using water recovered from the power generator as at least a portion of the input stream.

In some embodiments, the method further comprises transmitting electrical power to an electrical grid distribution system.

In some embodiments, the method further comprises using hydrogen generated by the electrolysis system to refuel vehicles that operate on hydrogen consuming fuel systems.

### BRIEF DESCRIPTION OF THE DRAWINGS

While the invention is claimed in the concluding portions hereof, preferred embodiments are provided in the accompanying detailed description which may be understood in conjunction with the accompanying diagrams where like parts in each of the several diagrams are labeled with like numerals, and where:

FIG. 1 is a schematic of an embodiment of a system for using excess power to store energy in the form of hydrogen and oxygen, which can then later be used to provide an energy source for electrical generation, or use as a fuel in hydrogen-powered systems.

### DETAILED DESCRIPTION OF THE INVENTION

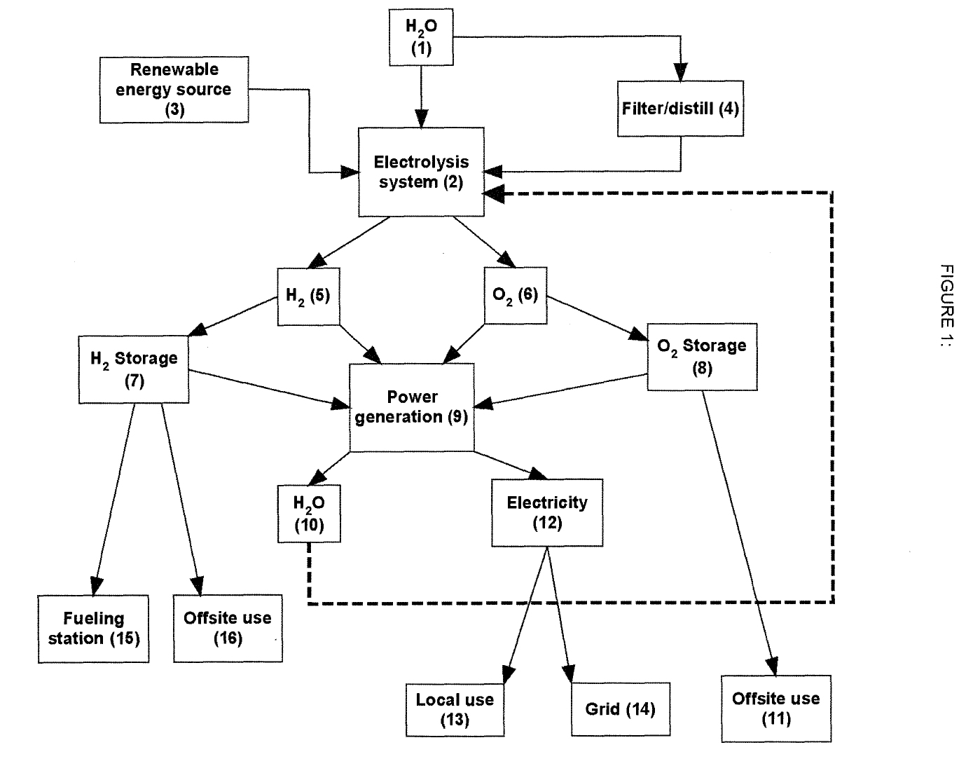

As depicted in FIG. 1, the present disclosure provides a system in which excess energy, for example of wind power or solar power, are converted to a storable energy form that can be used for a variety of purposes, including use to generate electrical power, for example when wind speed decreases, or at night time in the case of solar power facilities. The basic concept is that excess electrical power is used to electrolyze water into its chemical components, hydrogen and oxygen. Electrolysis of water produces these gases in the following stoichiometry:

2H₂O+electrical current=2H₂ (gas) and 2O₂ (gas)

In one embodiment, an input stream comprises water collected from a water source 1. The water can be pre-treated in a filtration and/or distillation system 4 to provide purified water that is then fed into a hydrolysis system 2. In some cases, the source of water can be seawater, freshwater, or water derived from operation of a power generator as described below. While pre-treatment of the water prior introduction into the hydrolysis system is not mandatory, it will reduce the amount of maintenance required to remove materials other than water that are present, and which will remain behind in the electrolysis system after the water has been broken down into hydrogen and oxygen.

Power to drive the electrolysis system is preferably derived from a renewable energy source 3. Suitable renewable energy sources include solar power, wind power, hydroelectric power, and the like. Power to drive the electrolysis system is provided in the form of electricity. Passage of electrical current through electrodes within a reaction chamber in the system in which water is introduced results in the hydrolysis of water into hydrogen 5 and oxygen 6. Under conditions of ambient temperature and pressure the hydrogen and oxygen will be liberated as gases, which can then be collected as separate output streams for storage 7, 8. Alternatively, the hydrogen and oxygen output streams can be fed directly into a power generator 9 to produce electric power 12 for use on-site 13, or for transmission to an electrical grid 14. Various types of power generation systems configured to produce electricity using the energy provided by the combustion of hydrogen and oxygen are contemplated and described below.

The exhaust from the reaction of hydrogen and oxygen within the power generator 9 will be pure water 10, initially in the form of water vapor due to the heat of combustion. In some embodiments, the system can be configured such that the water vapor output from the power generator can be condensed and fed back to the electrolysis system 2. In such cases, this closed loop system would limit the necessity of ongoing access to a large amount of water 1 as an input to the system. Alternatively, the water exhaust 10 from the power generator could be fed to a collector 10a, and either stored or transported through a pipeline, transport system or other means for other purposes requiring water.

Conveniently, because the water output from the power generator is substantially pure water, an advantage of the current system is that it can be used to process an impure, or otherwise contaminated source of water, to provide uncontaminated water. Thus, the current system can be used to process sources of water that are non-potable and/or used as a desalination system that does not use chemical means to remove salt and other constituents from seawater before to make it suitable for human consumption and other uses.

In some embodiments, the system can be configured to be a self-contained site for refueling vehicles and other systems that use hydrogen as a fuel source 15. In these cases, the hydrogen storage 7 can be fed into a delivery system included as part of a fueling station 15. The hydrogen and oxygen can also be transported by way of pipeline or other forms of transport for offsite use 11, 16. For example, oxygen produced by the present system is useful in applications other than fuel cells, including for industrial uses such as welding, or as a source of breathable oxygen for medical and aviation uses.

As described above, it may be preferable to remove various components that may be suspended in the water, for example particulates, algae, salts, dissolved metals, and the like. In some embodiments, purification of the water to be used in the electrolysis stage can be purified by techniques such as distillation, or reverse osmosis, with or without prior passage through a filtration medium. Where pre-filtering the water is desired, several possible methods may be used including, and without limitation, sand filters, diatomaceous earth filters, activated alumina, and other natural synthetic resins and compounds.

Once the water is in a condition for processing, it can then be transferred to an electrolysis system 2. This vessel comprises the various component required to electrolyze water into its component molecules hydrogen and oxygen, as well as means for separating the two gases from each other once produced.

The electrolysis system will include electrodes that will be immersed in the water. These electrodes can be connected electrically to a source of electrical power, such as that produce by a wind turbine, or from a solar-driven photovoltaic cell array 3. When power is applied to the vessel, electrical energy will electrolyze the water as described above, producing hydrogen and oxygen, which can then be separated and used as described herein.

For storage of hydrogen and oxygen, it is preferable that the liberated gases from the electrolysis step be stored in a compressed form. Thus, following collection of the gases the hydrogen and oxygen can be processed by liquefaction for hydrogen and oxygen storage 7,8. Conveniently, the liquefied gases can be stored in pressure vessels such as those know in the art. This permits stable storage until the hydrogen and/or oxygen are desired for use in other applications.

Use of the hydrogen and oxygen stored as above can be converted back to electrical energy using one of several forms of power generators 9 powered by the combustion of hydrogen and oxygen. In one embodiment, hydrogen and oxygen are combusted in a combustion chamber, and the heat of combustion can be used to produce steam to drive a steam turbine and electrical generator. In other embodiments, hydrogen and oxygen can be combusted to directly drive a gas turbine system, which in turns drive an electrical generator. In still other cases, hydrogen and oxygen can be combined in a hydrogen fuel cell to produce electricity.

Other advantages are provided by such a system in that once stored, the hydrogen and oxygen are effectively now portable. As a result, it may be possible to generate hydrogen and oxygen using excess power capacity in one location, and then transport the hydrogen and oxygen for consumption to produce electrical power at another location. For example, this could include places where all the components to drive the system (water, wind, sunshine) are not conveniently available in one place, or where it desirable to have portable sources of fuel and oxidizer to generate power, such as in vehicles, or in mining operations. Similarly, the hydrogen and oxygen can be used in an on-site power generation system to provide electrical power locally, as would needed in installations where the system was not connected to a traditional electrical grid.

As mentioned, another use of the system described would be to provide a self-contained fueling station that could provide hydrogen fuel for vehicles adapted to operate on hydrogen, either through hydrogen driven engines, or that use fuel cells to generate electrical power to drive electric motors. A network of such self-contained facilities could provide fueling options over large geographical areas more cheaply that current systems of centralized fuel production and distribution networks, which require large scale industrial operations for the extraction of fuel from non-renewable sources, and pipelines for distributing those fuel products.

A variety of other considerations will be obvious to those of skill in the art when considering implementation of a system such as disclosed herein. For example, it will be advantageous to place a system near a source of water, or otherwise provide water via a pipeline or other sufficient delivery means. Water use in the cracking vessel need not be pre-treated to remove impurities, but such treatment may be desirable to reduce the amount of maintenance required for various components of the system. Similarly, the choice of what type of system to use the stored hydrogen and oxygen to produce electrical energy may depend on several factors.

In addition, it will be apparent to those of skill in the art that by routine modification the present invention can be modified for use in a wide range of conditions and applications. It will also be obvious to those of skill in the art there are various ways and designs with which to produce the apparatus and methods of the present invention. The illustrated embodiments are therefore not intended to limit the scope of the invention, but to provide examples of the apparatus and methods to enable those of skill in the art to appreciate the inventive concept.

Those skilled in the art will recognize that any more modifications besides those already described are possible without departing from the inventive concepts herein. The inventive subject matter, therefore, is not to be restricted except in the scope of the appended claims. Moreover, in interpreting both the specification and the claims, all terms are to be interpreted in the broadest possible manner consistent with the context, hi particular, terms such as “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A system for converting energy from a renewable energy source into a storable form of energy, the system comprising:
a. a source of electrical energy, wherein the electrical energy is generated by a source from a source of renewable energy;
b. an input stream, the input stream comprising water,
c. an electrolysis system, the electrolysis system configured to use the source of electrical energy to convert the water into hydrogen and oxygen, wherein the electrolysis system further comprises separate hydrogen and oxygen output streams;
d. a hydrogen storage system;
e. an oxygen storage system;
f. a power generator, wherein the power generator is configured to use at least a portion of the hydrogen and oxygen generated by the electrolysis system to produce electrical power; and
g. a collector system, the collector system configured to collected exhaust created by the power generator, wherein the exhaust from the collector system can provide the input stream for the electrolysis system;
wherein the portion of hydrogen and oxygen not used by the power generator is available as a storable form of energy.

2. The system of claim 1, wherein the input stream is one of fresh water and sea water.

3. The system of claim 1, further comprising a water treatment system comprising at least one of a filtration system, a distillation system, and a deionizing system, the water treatment system configured to partially purify the input stream prior to introduction the input stream into the electrolysis system.

4. The system of claim 1, wherein the input stream comprises water recovered from the power generator.

5. The system of claim 1, wherein the system is configured to transmit electrical power to an electrical grid distribution system.

6. The system of claim 1, wherein the system is configured to refuel vehicles that operate on hydrogen consuming fuel systems.

7. A method for converting energy from a renewable energy source into a storable form of energy, the method comprising:
a. providing a source of electrical energy, wherein the electrical energy is generated by a source from a source of renewable energy;
b. providing an input stream, the input stream comprising water;
c. providing an electrolysis system, the electrolysis system configured to use the source of electrical energy to convert the water into hydrogen and oxygen, wherein the electrolysis system further comprises separate hydrogen and oxygen output streams;
d. introducing water into the electrolysis system;
e. operating the electrolysis system such that water is converted into hydrogen and oxygen gas;
f. providing a hydrogen storage system;
g. providing an oxygen storage system;
h. providing a power generator, wherein the power generator is configured to use at least a portion of the hydrogen and oxygen generated by the electrolysis system to produce electrical power;
i. providing a collector system, the collector system configured to collected exhaust created by the power generator, wherein the exhaust from the collector system can provide the input stream for the electrolysis system; and
j. storing the portion of the hydrogen and oxygen not used by the power generator.

8. The method of claim 1, wherein the input stream is one of fresh water and sea water.

9. The method of claim 1, further comprising:
a. providing a water treatment system, the water treatment system comprising at least one of a filtration system, a distillation system, and a deionizing system, the water treatment system configured to partially purify the input stream prior to introduction the input stream into the electrolysis system, and
b. processing the input stream with the water treatment system prior to introducing the input stream into the electrolysis system.

10. The method of claim 1, further comprising using water recovered from the power generator as at least a portion of the input stream.

11. The method of claim 1, further comprising transmitting electrical power to an electrical grid distribution system.

12. The method of claim 1, further comprising using hydrogen generated by the electrolysis system to refuel vehicles that operate on hydrogen consuming fuel systems.
